(19) United States
(12) Patent Application Publication
(10) Pub. No.: US 2017/0355382 A1
(43) Pub. Date: Dec. 14, 2017

(54) UTILIZATION OF A MULTI-TOUCH SMARTPHONE DISPLAY AS A TRACK PAD IN A MOTOR VEHICLE

(71) Applicants: Hyundai America Technical Center, Inc, Superior Township, MI (US); Hyundai Motor Company, Seoul (KR); Kia Motors Corporation, Seoul (KR)

(72) Inventors: Jennifer Wang, San Gabriel, CA (US); Joseph Jabour, Northville, MI (US); Alex Albanese, Ypsilanti, MI (US); Joseph Steffey, Brownstown Township, MI (US); Joshua Maxwell, Superior Township, MI (US); Mallory Stallworth, Plymouth, MI (US); Chadd Price, Livonia, MI (US)

(21) Appl. No.: 15/177,810

(22) Filed: Jun. 9, 2016

(51) Int. Cl. B60W 50/08; G06F 3/038; H04W 4/00; B60R 16/037; G06F 3/0354; B60H 1/00; B60Q 1/00; H04B 1/3827; G05B 15/02; H04L 29/08

(52) U.S. Cl. CPC B60W 50/08; H04B 1/3833; G06F 3/038; H04W 4/008; G05B 15/02; B60R 16/037; G06F 3/03547; B60H 1/00657; B60Q 1/0094; B60W 2540/04; G06F 2203/0384; H04L 67/12; B60W 2710/22; B60W 2710/30

(57) ABSTRACT

A multi-touch smartphone display used as a track pad in a motor vehicle is provided. A system includes a handheld device having a multi-touch display, a vehicle controller that transmits and receives data from the handheld device when the handheld device is docked into the vehicle, and a display that is mounted within the vehicle. The docked handheld device functions as a track pad to receive user input. The display is configured to display vehicle functions and applications on the handheld device. The vehicle controller is configured to transmit one or more commands to one or more vehicle components based on the received user input to execute the command.

### BACKGROUND

### (a) Field of the Disclosure

The prevent disclosure relates to the use of a multi-touch smartphone display as a track pad within a motor vehicle, and more particularly, to utilization of a multi-touch smartphone display as a track pad that reduces driver distraction.

### (b) Description of the Related Art

As a steadily increasing amount of technology is introduced into a motor vehicle, infotainment systems are becoming more complex and interfaces more cluttered. Currently, rotary controllers on the center console with surrounding hot keys and/or a touchscreen on the center fascia are used for control of vehicle functions. In both cases, the user needs to: (1) first locate the key with his or her eyes, which reduces the time focused on driving; and (2) physically actuate the command, which may require significant arm movement.

A method of the related art teaches controlling telematics system using a smartphone to send and receive commands via a programmed selection method. The multi-touch display of the smartphone, however, is not used as a track pad. Additionally, a vehicle having a touchpad installed in the steering wheel has been developed. However, such a touchpad is an integrated vehicle part and is not used in any other areas of the vehicle. That is, the touchpad is not part of a smartphone that is capable of being used a track pad. Accordingly, new means of control of infotainment systems may reduce driver distraction while carrying out commands and simplify controls in the vehicle.

The above information disclosed in this section is merely for enhancement of understanding of the background of the disclosure and therefore it may contain information that does not form the prior art that is already known in this country to a person of ordinary skill in the art.

### SUMMARY

The present disclosure provides techniques for utilizing a handheld device having a multi-touch display (e.g., a smartphone) as a track pad to control various functions of a vehicle.

In one aspect, the disclosure provides a system that may include a handheld device having a multi-touch display; a vehicle controller configured to transmit and receive data from the handheld device when the handheld device is docked into the vehicle; and a display mounted with the vehicle. The docked handheld device may operate in a track pad mode to receive user input and the display may be configured to display vehicle functions and applications from which the user input may be selected. The vehicle controller may be configured to transmit one or more commands to one or more vehicle components based on the received user input to execute the command.

In some exemplary embodiments, the handheld device may be a smartphone. The multi-touch display may be a homogenous color when the handheld device is in the track pad mode. Additionally, a dock for the handheld device may be disposed in a console between the front seats of the vehicle. The data between the handheld device and the vehicle controller may be transmitted via a wired connection or a wireless connection (e.g., via cellular data, Wi-Fi, or Bluetooth). Further, in the track pad mode the handheld device may be used to execute an application stored on the handheld device or a function of the handheld device (e.g., for phone services). The handheld device in track pad mode may also be used to control a vehicle setting and functions. For example, the handheld device in the track pad mode may be used for a display unit, a clock, an audio or radio function, a navigation system, a climate function, lighting, a safety feature, a camera, a seat function, a mirror, a steering wheel, and the suspension system of the vehicle. The multi-touch display of the handheld device in track pad mode may further be subdivided into segments assigned to a specific function and each segment may be assigned to a phone function, a climate function, a navigation system, or an audio function. A gesture may also be assigned to a specific function or command.

In another aspect, the disclosure provides a method that may include receiving a user input at a handheld device having a multi-touch display, wherein the handheld device is docked into a vehicle and is in a track pad mode; transmitting data between the handheld device and a vehicle controller when the handheld device is docked into the vehicle; transmitting a command to one or more components or applications based on the received user input to allow the transmitted command to be executed.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 is a system boundary diagram for an exemplary embodiment of the present disclosure;

FIG. 2 provides a process flow diagram for an exemplary embodiment of the present disclosure;

FIG. 3 provides an exemplary embodiment of the smartphone interface;

FIG. 4 provides an exemplary embodiment of the dashboard display; and

FIG. 5 provides an exemplary embodiment of the docking of the smartphone within the vehicle.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment. In the figures, reference numbers refer to the same or equivalent parts of the present disclosure throughout the several figures of the drawing.

### DETAILED DESCRIPTION

In the following detailed description, only certain exemplary embodiments of this disclosure have been shown and described, simply by way of illustration. As those skilled in the art would realize, the described exemplary embodiments may be modified in various different ways, all without departing from the spirit or scope of this disclosure. Accordingly, the drawings and description are to be regarded as illustrative in nature and not restrictive. Like reference numerals designate like elements throughout the specification.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. In addition, when it is described that an element is “coupled” to another element, the element may be “directly coupled” to the other element or “electrically coupled” to the other element through a third element.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Hereinafter, this disclosure will be described more fully with reference to the accompanying drawings, in which exemplary embodiments of the disclosure are shown.

The method and system described herein allow for various advantages and improvements in the operation of a vehicle. For example, the method and system described herein may result in the consolidation of vehicle controls in a small area as well as also allow for the reduction of hand and/or arm movement, thereby resulting in an improved human machine interface (HMI). In some exemplary embodiments, the control systems described herein reduce distraction while executing commands, as well as simplify controls in the vehicle by employing the availability and capabilities of a smartphone and setting up a track pad to be the main controller of, e.g., the infotainment system. Moreover, the use of a smartphone as a track pad for controlling vehicle functions and features also provides a more streamlined interior design that increases space availability within the vehicle for other uses (e.g., storage).

Further, the methods and systems described herein both utilize smartphone technology and increase the functionality of the smartphone. In certain exemplary embodiments described herein, charging of a smartphone by the vehicle's power source also reduces or eliminates the need for additional cables or cable routing to a power source; for example, a dedicated phone dock station may be provided.

The methods and the systems described herein may also be used for interface programmability. The smartphone data may be transferred to the vehicle and used within the vehicle environment. Indeed, in some exemplary embodiments as described herein, the built-in capabilities of a smartphone may be used to achieve simple control of the various functions of a vehicle. In particular, as described in more detail below, the smartphone may be inserted into a docking station (e.g., a dock) within the vehicle to transfer data between the vehicle controller and the smartphone while charging the smartphone. Once docked, the smartphone may connect to the vehicle infotainment system either via a wired or a wireless connection. All pertinent smartphone functions may be transferred to the display on the vehicle dashboard. That is, the smartphone display may be replicated on a vehicle display and a user may select an input therefrom via the track pad. The vehicle display may be a vehicle navigation system, but is not limited thereto.

The smartphone display may be switched to a track pad mode and, in some exemplary embodiments, may have one homogeneous color (e.g., a solid color may be output to resemble a track pad). In the track pad mode, the touch screen surface may be used to control the vehicle's audio, climate, navigation, phone, and/or settings functions, smartphone applications, etc. That is, as the driver interacts with the smartphone display, haptic feedback may be provided using the smartphone's vibration motor. Further, when the smartphone is not docked within the vehicle, the dashboard display may function as a touchscreen restricted to a dedicated area with limited capabilities.

In particular, as described herein, a smartphone may be used as a track pad to communicate via a computer system of a vehicle (e.g., a vehicle controller having processor and a memory) through a wired channel or a wireless channel to the respective wired communication module or wireless communication module of the vehicle. For example, use of the smartphone as a track pad may be used to relay instructions for a display unit, a clock, an audio system (e.g., radio), a map or navigation system, a climate control system, a lighting system, any advanced safety features, a camera system, any seat functions, a mirror, the steering wheel, the suspension system of the vehicle, and the like.

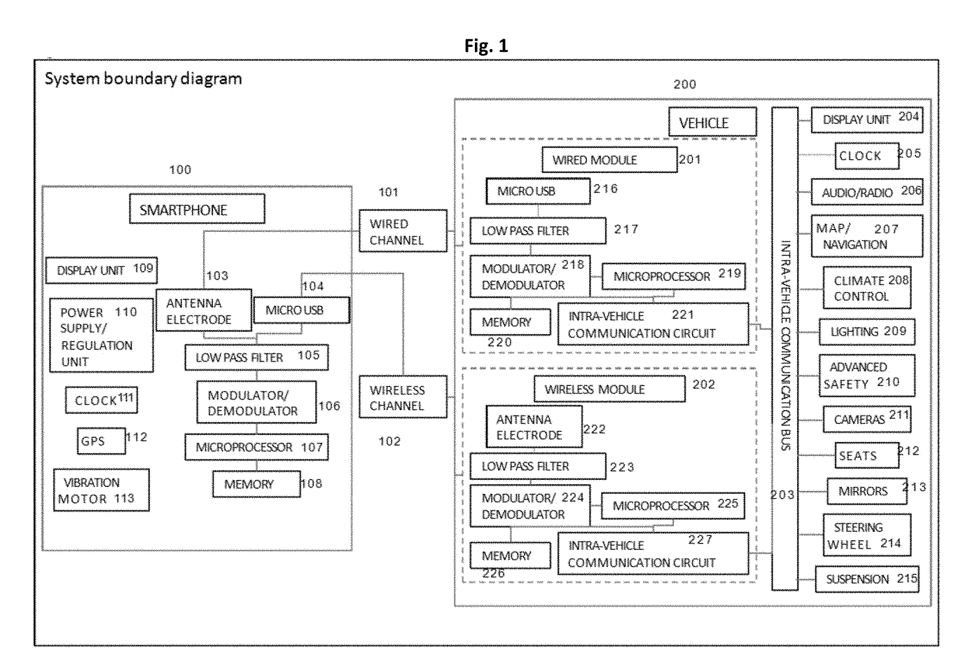

A system boundary diagram for an exemplary embodiment is provided as shown FIG. 1. As shown in FIG. 1, a smartphone 100 in a track pad mode may be configured to transmit and receive data from a vehicle 200 via wired channel 101 or wireless channel 102. In particular, a smartphone 100 having an antenna electrode 103, micro universal serial bus (USB) 104, low pass filter 105, modulator/demodulator 106, microprocessor 107, and memory 108 may be configured to transmit and receive data from antenna electrode 103 to wired channel 101, which then transmits and receives to and from vehicle wired module 201. The smartphone micro USB 104 may be configured to receive and transmit data to wireless channel 102 which also transmits and receives to and from vehicle wireless module 202.

Vehicle wired module 201 may include a micro USB 216, a low pass filter 217, a modulator/demodulator 218, a microprocessor 219, memory 220, and an intra-vehicle communication circuit 221. The vehicle wireless module 202 may include an antenna electrode 222, a low pass filter 223, a modulator/demodulator 224, a microprocessor 225, memory 226, and an intra-vehicle communication circuit 227.

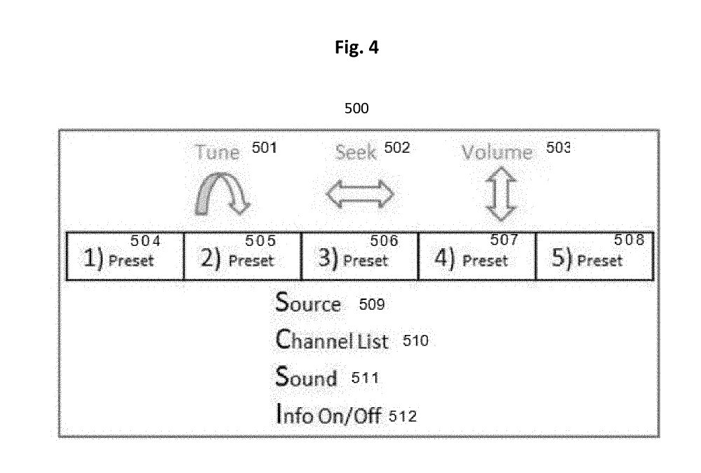

Intra-vehicle communication circuits 221 and/or 227 may be configured to transmit the input received from the user via intra-vehicle communication bus 203 to various vehicle components or functions, including but not limited to a display unit 204 (e.g., selecting features or statuses to be shown on the display unit), a clock 205 (e.g., adjusting the time displayed or setting a timer to record duration of travel), an audio system 206 (e.g., radio; see, e.g., FIG. 4 and exemplary embodiments described herein), a map or navigation system 207 (e.g., selecting a point of origin, selecting a destination, selecting a travel route, or modification of a travel route), a climate control system 208 (e.g., setting a target temperature, turning a heating system on or off, turning an air-conditioning system on or off, or turning a fan on or off), a lighting system 209 (e.g., turning an interior light on or off), any advanced safety features 210, a camera system 211 (e.g., turning a rear camera on or off or capturing an image), any seat functions 212 (e.g., changing a seat position, changing the angle of recline of a seat, or adjusting the temperature of a seat), a mirror 213 (e.g., adjusting the position of a mirror), the steering wheel 214, or the suspension system of the vehicle 215. The smartphone 100 may also include a display unit 109, a power supply/regulation unit 110, a clock 111, a GPS 112, and a vibration motor 113.

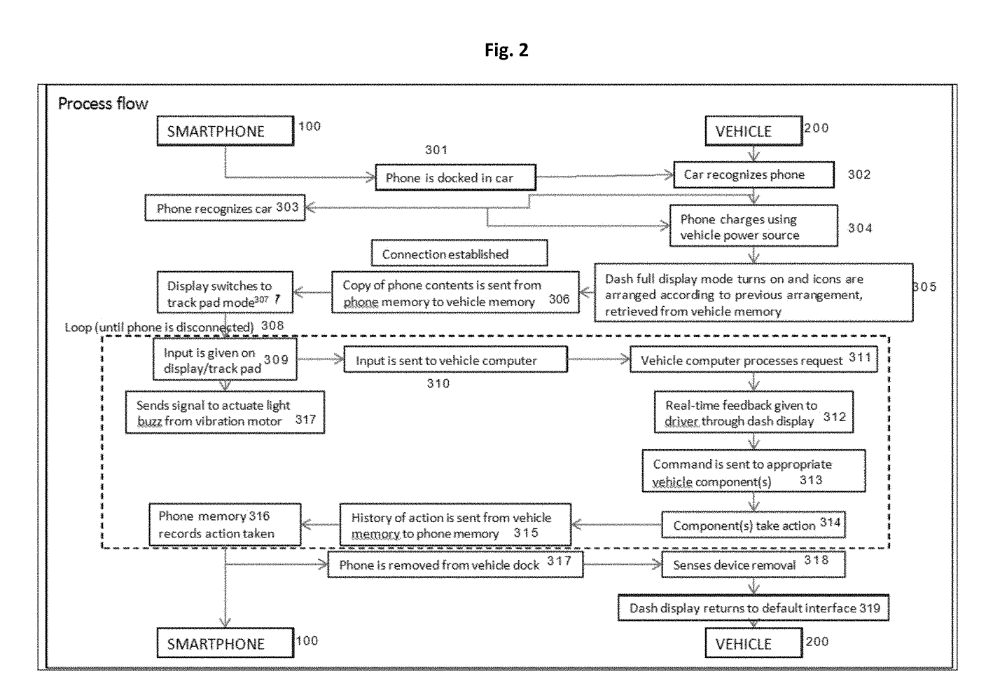

A process flow for an exemplary embodiment is provided as shown in FIG. 2. In particular, as shown in FIG. 2, a handheld device (e.g., a smartphone 100) may be docked into (e.g., connected to) a vehicle 200 (step 301). The vehicle may then be configured to recognize the smartphone via, wireless or wired methods (step 302). For example, a vehicle controller may be configured to recognize the smartphone. The smartphone may be configured to recognize the vehicle by wireless or wired methods (step 303). The vehicle may also provide power to the smartphone (e.g., to charge the smartphone) using a vehicle power source (step 304).

After docking the handheld device to the vehicle, a full display mode in the dashboard may be turned on (step 305). In the full display mode, icons may be output and arranged based on previous positioning through retrieval from vehicle memory, or may be arranged de novo (step 305). Contents of the handheld device may then be transmitted to the vehicle memory (e.g., an entire or partial copy of the smartphone contents may be transmitted to the vehicle; step 306). The handheld may then be used as a track pad and the display of the handheld device may be configured to switch to track pad mode (step 307).

An exemplary communication loop (308) between the smartphone and the vehicle will be described herein below. First, the track pad of the smartphone may be configured to receive a user input (step 309), which may be transmitted to the vehicle controller via wired or wireless methods (step 310). The vehicle controller may be configured to process the request (step 311) to provide real-time feedback to the user (e.g., the driver) through the dashboard display (step 312). The command may be transmitted to an appropriate vehicle one or more components (step 313) and the component may be configured to execute the corresponding action (step 314). The history of an action or actions (e.g., command requests) may be transmitted from the vehicle memory to the smartphone memory (step 315), which may be configured to store the executed action (step 316). When the use of the smartphone as a track pad is to be terminated, the smartphone may be removed from the vehicle dock (step 317). The vehicle may be configured to detect the device removal (step 318) and the dashboard display may return to a default interface (step 319).

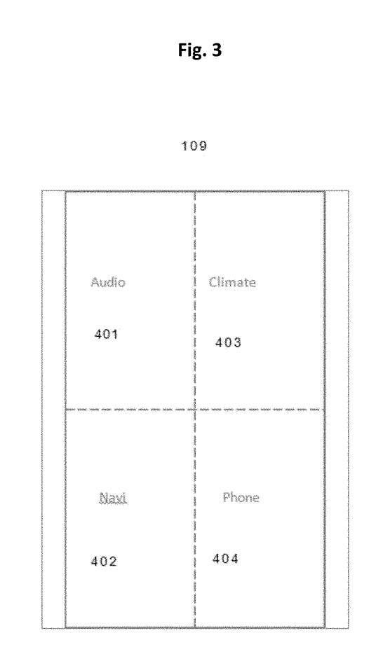

A smartphone display 109 may also be divided into multiple segments when the smartphone is in a track pad mode. For example, the smartphone display may be divided into four quadrants, wherein each quadrant may be touched by a user (e.g., pressure may be exerted within a quadrant) to quickly access a corresponding function. The selection is based on the corresponding location on dashboard display. See FIG. 3. For example, as seen in FIG. 3, quadrant 401 may provide access to audio functions; quadrant 402 may provide access to a navigation system of the vehicle; quadrant 403 may provide access to a climate control system of the vehicle; and quadrant 404 may provide access to phone functions.

A specific gesture may also be used to access particular functions or applications. For example, the system may be configured to receive input wherein a user traces a letter on the multi-touch display of the smartphone in a track pad mode. Accordingly, the vehicle controller may be configured to detect the letter input by the user and correlate the input to a particular function. For example, a user may select the audio system by drawing the letter A, the climate control system by drawing the letter C, the navigation system by drawing the letter N, the phone functions by drawing out the letter P, or general settings by drawing the letter S on the smartphone multi-touch display.

An exemplary dashboard display 500 for an audio system is provided in FIG. 4. The dashboard display 500 may feature five preset radio stations (504-508). The dashboard display 500 may also include a display that identifies features such as audio source 509, channel list 510, sound 511, and information display on/off options 512. Exemplary gestures that may be used include a clockwise circle gesture 501 for tuning, a left/right swiping gesture 502 for seeking a track or a radio station, and an up/down swiping gesture 503 for adjusting the volume, but the disclosure is not limited thereto. When a function is selected, the driver may perform select default gestures that may quickly execute several frequently accessed actions. Each action may be displayed with a corresponding gesture symbol on the dashboard display for user reference. Exemplary assigned gestures are shown in Table 1.

TABLE 1

| | |
|---|---|
| Audio: | Clockwise circle: radio tuning |
| | Left/right swiping: seek track |
| | Up/down swiping: volume adjustment |
| Climate: | Clockwise circle: fan speed |
| | Left/right swiping: air conditioning or |
| | heating selection |
| | Up/down swiping: temperature adjustment |
| Navigation: | Free movement: map movement |
| | Pinching: zoom in/out |
| Phone: | Left/right swiping: accept or reject call |
| | Up/down swiping: contact list selection |
| | Up/down swiping: volume adjustment |
| | (during call) |

Still other exemplary gestures include the pinching of the display of the track pad with user fingers to close an application and return to the home page or home screen. A user may use an up/down swiping motion to scroll through option lists or a double-tapping gesture to select an option. A user may use free movement about smartphone display to move icons on vehicle display. The present disclosure is however, not limited to such motions, and other well-known motions may also be used to control the applications displayed.

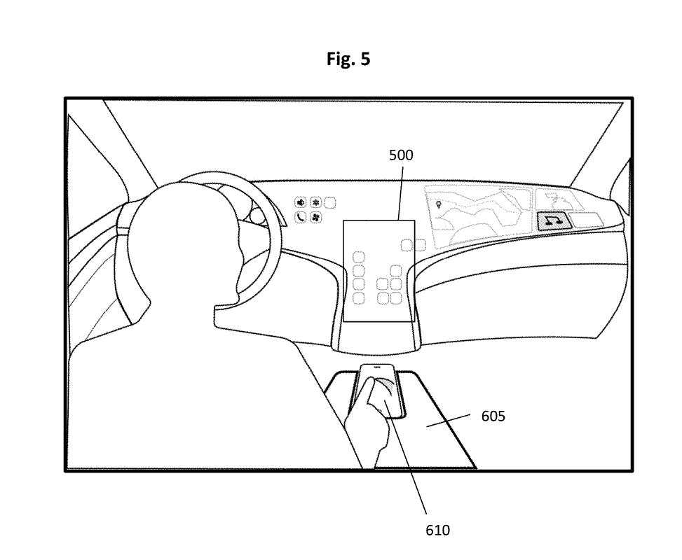

Moreover, FIG. 5 illustrates the docking of the smartphone 100 within the vehicle. In particular the smartphone 100 may be inserted into a docking station 605 mounted within the vehicle to transfer data between the vehicle controller and the smartphone 100 while charging the smartphone 100. The docking station 605 may be provided at a center console within the vehicle, but the location of the docking station is not limited thereto. Further, once the smartphone 100 has been inserted into the docking station 605, the smartphone 100 may be configured to connect to a vehicle infotainment system either by a wired or wireless connection. Accordingly, various smartphone functions may then be transferred to the display of a vehicle dashboard 500. In particular, the smartphone display may be replicated on the dashboard display 500. Once transferred, the smartphone display may be used in the track pad mode, that is, the smartphone 100 may be switched to the previously discussed track pad mode 610. In some embodiments, once in the track pad mode, the smartphone display may output a homogenous color.

Additionally, once in the track pad mode, the touch screen of the smartphone 10 may be used to control various vehicle functions such as audio, climate, navigation, phone, setting functions, and the like together with various smartphone applications. During the use of smartphone in the track pad mode, as a user or driver interacts with the smartphone display, haptic feedback may be output using a vibration motor of the smartphone, as previously discussed herein above. Accordingly, a driver may advantageously operation vehicle functions by employing the capabilities of a smartphone.

The foregoing description has been directed to embodiments of the present disclosure. It will be apparent; however, that other variations and modifications may be made to the described embodiments, with the attainment of some or all of their advantages. Accordingly, this description is to be taken only by way of example and not to otherwise limit the scope of the embodiments described herein. Therefore, it is the object of the appended claims to cover all such variations and modifications as come within the spirit and scope of the embodiments herein.

What is claimed is:

1. A system, comprising
a handheld device having a multi-touch display;
a vehicle controller configured to transmit and receive data from the handheld device when the handheld device is docked into the vehicle; and
a display mounted within the vehicle;
wherein the docked handheld device operates in a track pad mode to receive user input,
wherein the display is configured to display vehicle functions and applications from which the user input is selected, and
wherein the vehicle controller is configured to transmit one or more commands to one or more vehicle components based on the received user input to execute the command.

2. The system of claim 1, wherein the handheld device is a smartphone.

3. The system of claim 1, wherein the multi-touch display is a homogenous color when the handheld device is in the track pad mode.

4. The system of claim 1, wherein a dock configured to receive the handheld device is disposed in a console between front seats of the vehicle.

5. The system of claim 1, wherein data is transmitted between the handheld device and the vehicle controller via a wired connection.

6. The system of claim 1, wherein data is transmitted between the handheld device and the vehicle controller via a wireless connection.

7. The system of claim 6, wherein the wireless connection is via cellular data, Wi-Fi, or Bluetooth.

8. The system of claim 1, wherein the handheld device in the track pad mode is used to execute an application stored on the handheld device or a function of the handheld device.

9. The system of claim 8, wherein the handheld device in track pad mode is used for phone services.

10. The system of claim 1, wherein the handheld device in track pad mode is used to control a vehicle settings and functions.

11. The system of claim 10, wherein the handheld device in the track pad mode is used for at least one selected from the group consisting of: a display unit, a clock, an audio or radio function, a navigation system, a climate function, lighting, a safety feature, a camera, a seat function, a mirror, a steering wheel, and the suspension system of the vehicle.

12. The system of claim 1, wherein the multi-touch display of the handheld device in track pad mode is subdivided into segments assigned to a specific function.

13. The system of claim 12, wherein each segment is assigned to a phone function, a climate function, a navigation system, or an audio function.

14. The system of claim 1, wherein a gesture is assigned to a specific function or command.

15. A method, comprising:
receiving user input at a handheld device having a multi-touch display, wherein the handheld device is docked into a vehicle and is in a track pad mode;
transmitting data between the handheld device and a vehicle controller when the handheld device is docked into the vehicle; and
transmitting a command to one or more components or applications based on the received user input to allow the transmitted command to be executed,
wherein a display that is configured to display vehicle functions and applications from which the user input is selected.

16. The method of claim 15, wherein the handheld device is a smartphone.

17. The method of claim 15, wherein the data is transmitted between the handheld device and the vehicle controller via a wired connection.

18. The method of claim 15, wherein the data is transmitted between the handheld device and the vehicle controller via a wireless connection.
